(19) United States
(12) Patent Application Publication
(10) Pub. No.: US 2007/0131478 A1
(43) Pub. Date: Jun. 14, 2007

(54) Speaker, speaker-use diaphragm, dust cap, production methods and production devices for them

(76) Inventors: Masatoshi Okazaki, Hyogo (JP); Masaki Suzumura, Mie (JP); Shinya Mizone, Mie (JP); Yoshimichi Kajihara, Osaka (JP); Kazuaki Nishimura, Mie (JP); Masahide Sumiyama, Mie (JP)

Correspondence Address: WENDEROTH, LIND & PONACK L.L.P., 2033 K. STREET, NW, SUITE 800, WASHINGTON, DC, 20006, US

(21) Appl. No.: 10/576,964

(22) PCT Filed: Feb. 1, 2005
(86) PCT No.: PCT/JP05/01375

§ 371 Date: Apr. 25, 2006

(30) Foreign Application Priority Data
Feb. 18, 2004 (JP) 2004-014113
Feb. 18, 2004 (JP) 2004-041114
Mar. 5, 2004 (JP) 2004-061969

(51) Int. Cl. H04R 7/00

(52) U.S. Cl. 181/167

(57) ABSTRACT

A speaker diaphragm or a dust cap formed by injection molding a mixture at least containing a resin material and a fiber material. The speaker diaphragm or the dust cap combines the advantages of both a paper diaphragm and a resin diaphragm. The advantage of a paper diaphragm is a large degree of freedom in setting physical properties. The advantages of a resin diaphragm are being excellent in moisture resistance reliability, strength, external appearance, productivity and dimension stability.

### TECHNICAL FIELD

The present invention relates to a speaker diaphragm and a dust cap which are used in various types of audio and video equipment.

### BACKGROUND ART

FIG. 9 shows a conventional speaker diaphragm formed by resin injection molding. FIG. 10 shows a conventional dust cap. Speaker diaphragm 207 and dust cap 209 shown respectively in FIGS. 9 and 10 are formed by melting pellets of polypropylene or other resins and then by injection molding the melted resin in their respective molds. The prior art will be described as follows by focusing on diaphragms.

As a material for injection molding, a polymer material such as polypropylene is commonly used on its own. Besides, a blend-type material containing different types of resins is often used to adjust the physical properties of the diaphragm or the dust cap, thereby adjusting the performance and audio quality of the speaker. It is also possible to add reinforcement such as mica to the molding material in order to obtain the physical properties that are hard to get by using resin only, thereby adjusting the performance and audio quality of the speaker.

The prier art related to the invention of the present application includes Japanese Patent Unexamined Publication No. 59-176995 and No. H03-289298.

With remarkable progress in digital technology, there has been a marked improvement in the performance of audio equipment and video equipment (hereinafter, collectively referred to as audio/video equipment) and also in the performance of devices including cars mounted with such equipment.

In recent years, the audio quality of the audio/video equipment is getting more and more realistic with a lower distortion, a wider bandwidth and a larger dynamic range. On the other hand, there has also been a marked improvement in the performance of video due to higher definition and the appearance and spread of large-scale modules as used in plasma display. Along with the improvement in the performance of audio/video equipment, there is a strong demand from the market for improved speakers used in the equipment.

In order to improve speaker performance, it is essential to improve the performance of the diaphragm and the dust cap which have more influence to determine the audio quality of the speaker than the other components.

Most diaphragms are manufactured by classical paper making, resin injection molding or pressing, so that paper diaphragms and resin diaphragms are in the mainstream. The two types of diaphragms have been separately used depending on application by taking advantage of the desirable features of paper or resin. However, they have their own problems and cannot meet the demand for high performance.

More specifically, paper diaphragms can have physical properties with higher precision so as to allow the speaker to have performance and audio quality adjusted in a wider range. On the other hand, they are poor in moisture resistance reliability and strength, which are features unique to paper. As another disadvantage of paper diaphragms, the paper making requires a large number of processes.

In contrast, resin diaphragms are excellent in moisture resistance reliability, strength, external appearance and productivity; however, they only have uniform physical properties unique to resin. As a result, resin diaphragms can allow the speaker to have performance and audio quality adjusted only in an extremely narrow range.

Therefore, the manufacturing of speakers has been required to choose between a paper diaphragm and a resin diaphragm by taking advantage of its desirable features. This holds true for dust caps.

A conventional method and facility for manufacturing a resin diaphragm will be described as follows with reference to FIG. 11. FIG. 11 is a process chart showing the conventional method and facility for manufacturing a diaphragm by injection molding. In FIG. 11, resin 221, which is polypropylene (hereinafter, PP) and PP 222 containing reinforcement such as mica are dry-blended. Next, resulting master batch 223 is pelletized using pelleting machine 224. Then, resulting master batch pellets 225 are placed into injection molder 226.

In injection molder 226, master batch pellets 225 are melted and injected into injection mold 227 for diaphragms using an extruder. The PP injected into injection mold 227 is taken out of injection mold 227 after it is cooled and hardened. Through these injection molding processes, resin diaphragm 228 made of PP and the like is complete.

As a resin material for injection molding, PP is commonly used on its own. Besides, a blend-type material containing different types of resins is often used to adjust the physical properties of the diaphragm, thereby adjusting the performance and audio quality of the speaker. The blend-type resin material is obtained by grinding necessary types of resin pellets in a grinder and then dry-blending them in a predetermined ratio.

The prier art related to the invention of the present application further includes Japanese Patent Unexamined Publication No. H1-248900.

With remarkable progress in digital technology, there has been a marked improvement in the performance of electronic equipment such as audio equipment and video equipment. Along with the improvement in the performance of the electronic equipment, there is a strong demand from the market for improved speakers used in the equipment.

In order to improve speaker performance, it is essential to improve the performance of the diaphragm and the dust cap which have more influence to determine the audio quality of the speaker than the other components. To improve the performance of diaphragms, resin diaphragms have been popular recently because of their stable quality, water resistance reliability and design diversity.

Resin diaphragms, however, can allow the speaker to adjust performance and audio quality only within the range of the material properties of resins, so that the speaker can create nothing but standardized sound only. This makes it impossible for the speaker to create diverse sound or to have its characteristics adjusted in a wider range so as to meet the market demand. In this situation, it is expected to manufacture a resin diaphragm whose physical properties can be adjusted as precisely as in paper diaphragms, thereby allowing the speaker to have performance and audio quality adjusted in a wider range.

To achieve a resin diaphragm with such characteristics, one possible approach is to blend a resin and pulp, which is a raw material of paper. In the current method for manufacturing a diaphragm with the current facility, that is, dry blending method, it is possible to blend different types of resins. When a resin is mixed with pulp, however, the pulp cannot be dispersed evenly in the resin. As a result, the speaker cannot have the desired performance and audio quality.

### SUMMARY OF THE INVENTION

The diaphragm and dust cap of the present invention are formed by injection molding a material containing at least a resin material and a fiber material. As a result, the diaphragm and dust cap can combine the advantages of both paper and resin. More specifically, the diaphragm and the dust cap can have a large degree of freedom in setting physical properties as the advantage of paper, and be excellent in moisture resistance reliability, strength, external appearance, productivity and dimension stability as the advantages of resin. This achieves the creation of characteristics and sound of the speaker by making use of the physical properties of both paper and resin, which have not been achieved conventionally.

Furthermore, the speaker can have characteristics adjusted as precisely as never before by the proper selection of materials for the diaphragm or the dust cap from fiber materials, resin materials and reinforcement materials, and by the proper determination of the ratio between them.

Furthermore, different color combinations of materials used in the diaphragm or the dust cap can allow the speaker to be designed diversely. In addition, the diaphragm or the dust cap can be manufactured in infinite color combinations so as to make the speaker meet the demand for design in addition to the demands for the creation of performance and sound.

The method of the present invention is a method for manufacturing a speaker diaphragm or a dust cap by injection molding a material containing at least a resin and a filler. In the method, fibrous resin and filler are wet mixed and dehydrated to form a primary composite material. Then, the primary composite material is complexed again with granular resin which is ground in a separate process so as to form a secondary composite material. Finally, the secondary composite material is injection molded.

In the manufacturing method, fibrous resin and filler are wet mixed to form a primary composite material in a process, while granular resin is formed by grinding the resin in a separate process. The primary composite material and the granular resin are complexed again in a second complexing process, which substitutes the resin for moisture to make them well blended, thereby drawing out the advantages of both the resin and the filler.

In the manufacturing method of the present invention, fibrous resin and filler are wet mixed to form a primary composite material in a process, while granular resin is formed by grinding the resin in a separate process. The primary composite material and the granular resin are complexed again in a second complexing process. This method allows the moisture generated in the wet mixing for forming the primary composite material to be evaporated in the subsequent process for forming the secondary composite material. At the same time, the resin is melted to make it well blended with the filler.

In short, the manufacturing method substitutes the resin for moisture to make the resin and the filler well blended, thereby drawing out the advantages of both the resin and the filler. As a result, a speaker using this diaphragm can have performance and audio quality adjusted in a wide range, and be excellent in moisture and water resistance reliability, strength and external appearance.

Furthermore, the method and facility of the present invention for manufacturing a diaphragm can achieve the physical properties of a paper diaphragm with high productivity and stability, which used to be obtained through a long paper-making process.

The present invention, which provides a method and facility for manufacturing a speaker diaphragm or a dust cap combining the advantages of both the resin and the filler, has an extremely high industrial value.

### BRIEF DESCRIPTION OF THE DRAWINGS

FIG. 1 is a cross sectional view of a speaker diaphragm of an embodiment of the present invention.

FIG. 2 is a plan view of the speaker diaphragm of an embodiment of the present invention.

FIG. 3 is a cross sectional view of a speaker of an embodiment of the present invention.

FIG. 4 is an external view of electronic equipment of an embodiment of the present invention.

FIG. 5 is a cross sectional view of a device of an embodiment of the present invention.

FIG. 6 is a process chart showing a method of an embodiment of the present invention for manufacturing a speaker diaphragm.

FIG. 7 is a cross sectional view of a speaker dust cap of an embodiment of the present invention.

FIG. 8 is a cross sectional view of a speaker of an embodiment of the present invention.

FIG. 9 is a cross sectional view of a conventional speaker diaphragm.

FIG. 10 is a cross sectional view of a conventional dust cap.

FIG. 11 is a process chart showing a conventional method for manufacturing a speaker diaphragm.

### REFERENCE MARKS IN THE DRAWINGS

21 magnet
22 upper plate
23 yoke
24 magnetic circuit
25 magnetic gap
26 frame
27 diaphragm
27A resin material
27B fiber material
28 voice coil
29 edge
30 speaker
41 enclosure
42 amplifier
43 player
44 mini component system
50 car
101 fibrous PP
102 pulp
103 wet mixer
104 primary composite material
105 dehydrator
106 pp pellet
107 grinder
108 granular PP
109 mixer
110 secondary composite material
111 pelleting machine
112 pp pellet
113 mold
114 injection molder
115 diaphragm
116 reinforcement
117 diluent resin
118 mixing machine
120 manufacturing facility
129 dust cap
129A resin material
129B fiber material

### DETAILED DESCRIPTION OF THE PREFERRED EMBODIMENTS

Embodiments of the present invention will be described as follows with reference to accompanying drawings.

### First Exemplary Embodiment

A first embodiment will describe a speaker diaphragm of the present invention.

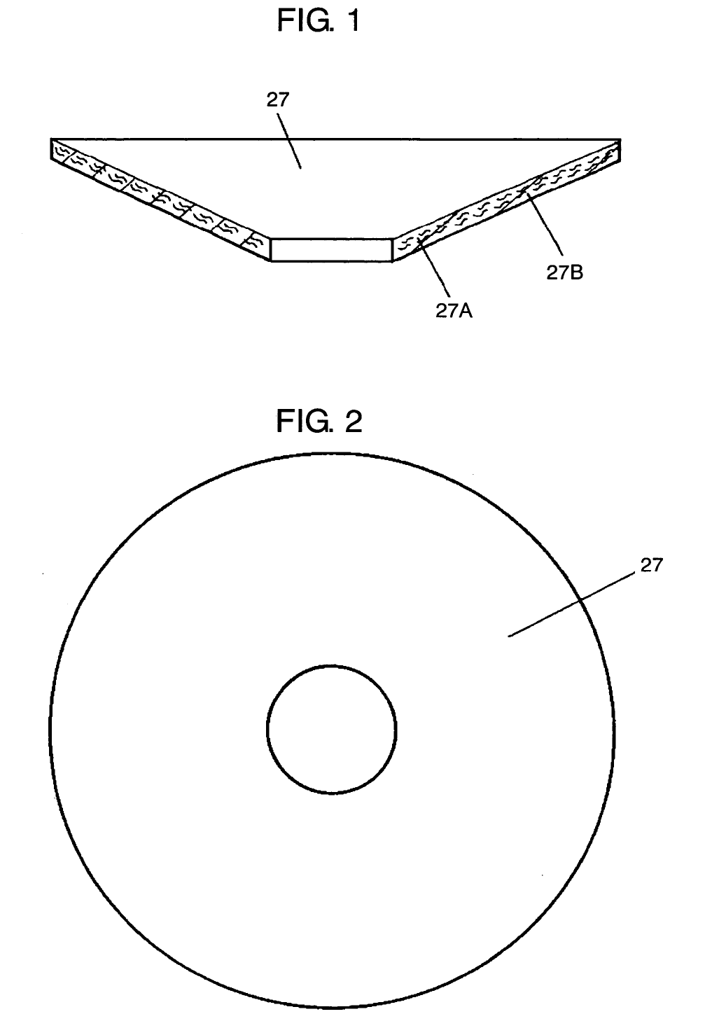

FIGS. 1 and 2 show the diaphragm of the embodiment of the present invention. Diaphragm 27 is formed by injection molding a material containing resin material 27A and pulp 27B. As resin material 27A of diaphragm 27, a crystalline or amorphous olefin resin is used.

Using an olefin resin can provide excellent formability. Furthermore, choosing between a crystalline resin material and an amorphous resin material depending on application can allow the diaphragm to have its optimum physical properties.

The following is a description of the case where resin material 27A is made of polypropylene. Polypropylene is easily available and easily injection-molded. Note that the present invention can use various types of resin materials besides polypropylene, depending on the desired properties. For example, when the diaphragm is required to be highly resistant to heat and solvent, the requirement can be satisfied by using engineering plastic such as polyethylene terephthalate (PET) or polybutylene terephthalate (PBT).

In diaphragm 27 of the first embodiment, resin material 27A as the base is made of polypropylene, and fiber material 27B is made of craft pulp, which is wood fiber. While diaphragms exclusively made of resin often create dark and monotonous tones, diaphragms made of a mixture of resin and wood fiber can create natural and bright tones. Besides craft pulp, it is also possible to use sulfite pulp, or a fiber blend of craft pulp and sulfite pulp so as to approach the desired performance and audio quality of the speaker.

Fiber material 27B can alternatively be made of one or a combination of the following materials: a cellulose fiber material such as leaf fiber, bast fiber, seed fiber, fruit fiber, or stem fiber, and an animal fiber material. Adding an appropriate amount of these materials can further approach the desired performance and audio quality of the speaker. Leaf fiber tends to improve the strength of diaphragm 27, and as this fiber type, manila hemp is often used. Bast fiber tends to improve the toughness of diaphragms, and as this fiber type, paper mulberry, Edgeworthia, Gampi (tissue paper) and hemp are often used. Seed fiber tends to increase the internal loss of diaphragms, and as this fiber type, cotton and linter are often used. Fruit fiber also tends to increase the internal loss of diaphragms, and as this fiber type, kapok is often used. Stem fiber tends to improve the elasticity of diaphragms, and of this fiber type, bamboo, bamboo leaf, kenaf, straw and the like can be used. In order to achieve the audio quality of the speaker that cannot be obtained by using vegetable fiber, animal fiber such as silk or wool can be added so as to precisely adjust the strength and internal loss of the diaphragm.

The diaphragm material can be added with the following reinforcements: metal fiber such as aluminum; carbon fiber such as carbon; ceramic fiber such as glass or boron; organic high modulus fiber such as aramid; mica; or graphite. Adding such reinforcement can strengthen the diaphragm or adjust the audio quality of the speaker by producing accented sound or by providing sound pressure frequency characteristics with peaks.

The diaphragm material can be also added with zinc oxide whisker or the like so as to achieve the audio quality with internal loss that cannot be satisfied by using the aforementioned materials only.

The afore-described materials can be used either on their own or in combination to adjust the physical properties of the diaphragm both in a wider range and with high precision, thereby achieving the desired performance and audio quality of the speaker.

The desired performance and audio quality of the speaker, which can be achieved with considerable know-how about producing physical properties and sound, are commonly achieved as follows.

The performance of the speaker can be adjusted to some extent by varying the parameters of its components so as to approach the desired performance and audio quality. For example, if the parameters of the speaker components other than the diaphragm are fixed, the variable parameters of the diaphragm include area, shape, weight and thickness, besides the physical properties. If the area, shape, weight and thickness of the diaphragm are fixed, conditions other than the physical properties of the diaphragm roughly determine the sound pressure frequency performance and audio quality of the speaker. In this case, unnecessary peaks and dips are observed in the sound pressure frequency characteristics, and large distortions are often generated in a specific frequency range. The audio quality, on the other hand, is largely influenced by the sound pressure frequency characteristics. The properties of the speaker including the sound pressure frequency characteristics and audio quality are affected by the specifications of the diaphragm such as area, shape, weight and thickness. This is because these specifications determine the vibration mode of the diaphragm.

The present invention can be applied for the selection of diaphragm materials to eliminate the unnecessary peaks, dips or distortion described above, thereby providing a speaker with excellent audio quality. First of all, some materials are selected from resin materials, fiber materials and the like, considering whether they meet the sound pressure frequency characteristics, audio quality and reliability grade required for the speaker. The resin material as the base is selected from those having high reliability including a high heat resistant grade and also from those having a unique tone close to the desired tone. Then, another material is selected from those being effective to eliminate the unnecessary peaks and dips on the sound pressure frequency characteristics. For dip elimination, a material which resonates with the frequency is selected. For peak elimination, on the other hand, a material having internal loss in the frequency is selected. The material selection is performed by considering the density, elasticity, internal loss, tone, and resonance frequency obtained when the diaphragm has been shaped, with respect to each of the resin material, fiber material and other additional materials.

The selected materials are kneaded to prepare master batch pellets with high pulp content. The master batch pellets with high pulp content are injection molded to form diaphragm 27 of the present embodiment.

Diaphragm 27 thus obtained is measured and evaluated for its physical properties and the like. A speaker is prototyped with diaphragm 27 so as to measure the performance and audio quality of the speaker, and also to listen through the speaker as the final evaluation.

When the evaluation indicates that the speaker does not achieve the desired performance and audio quality, the prototyping process is repeated over and over again. During the process, the selection and ratio of the materials are considered so as to gradually approach the target performance and audio quality of the speaker.

Repeating these processes can achieve the desired or similar performance and audio quality of the speaker.

The fiber material used for the diaphragm of the present invention preferably has a fiber length of 0.2 mm to 20 mm. The length of this range can maximize the effectiveness of the fiber material when it is kneaded with a resin material, thereby improving the productivity and quality of the diaphragm. When the fiber length is less than 0.2 mm, the effectiveness of the fiber material cannot be maximized. When the fiber length is more than 20 mm, on the other hand, the fiber materials are tangled with each other to cause secondary aggregation, thereby resulting in the poor dispersion of the fiber material. This either requires a long kneading time or causes the pulp fiber to be exposed on the surface of the diaphragm, thus spoiling the appearance.

The fiber material is added to the resin material preferably at a rate of 5% to 70%. This rate range can maximize the effectiveness of the fiber material when it is kneaded with the resin material, and can also improve the productivity and quality of the diaphragm. When the rate of the pulp is less than 5%, the pulp addition has little effect. When the rate is more than 70%, on the other hand, the pulp shows its disadvantages, thereby decreasing all of the strength, productivity, moisture resistance reliability and dimension stability of the diaphragm.

In the case where a diaphragm is expected to be black in terms of external design, natural-color pulp is colored with a black dye, while the resin material is kneaded with a black pigment to form black resin pellets. As another method of coloring a diaphragm, natural-color pulp and natural-color resin material can be kneaded first, and then a black pigment can be added when master batch pellets with high pulp content are produced. Such a black diaphragm can have a similar design as the conventional diaphragms.

The aforementioned coloring method can be used to make the diaphragm any other colors than the black. Alternatively, it is possible to leave the diaphragm its natural color without using any coloring agents such as dyes or pigments, thereby designing the diaphragm with natural and environmentally friendly colors.

As another design, the fiber material and the resin material can be in different colors from each other so that the single diaphragm can make an appeal that it includes both materials. In this case, it is preferable to choose a transparent or semi-transparent resin.

As described hereinbefore, the first embodiment relates to a speaker diaphragm made by injection-molding a mixture which contains a resin material and a fiber material. The present invention can provide a diaphragm which combines the advantages of both a paper diaphragm and a resin diaphragm. More specifically, the diaphragm has a large degree of freedom in setting physical properties as the advantage of a paper diaphragm. The diaphragm is also excellent in moisture resistance reliability, strength, external appearance, productivity and dimension stability as the advantages of a resin diaphragm.

As a result, the diaphragm of the present invention allows the creation of performance and sound of the speaker by making use of the physical properties of both a paper diaphragm and a resin diaphragm, which have not been achieved by conventional diaphragms. Furthermore, the color combination between the fiber material and the resin material in the diaphragm enables the speaker to be designed diversely.

### Second Exemplary Embodiment

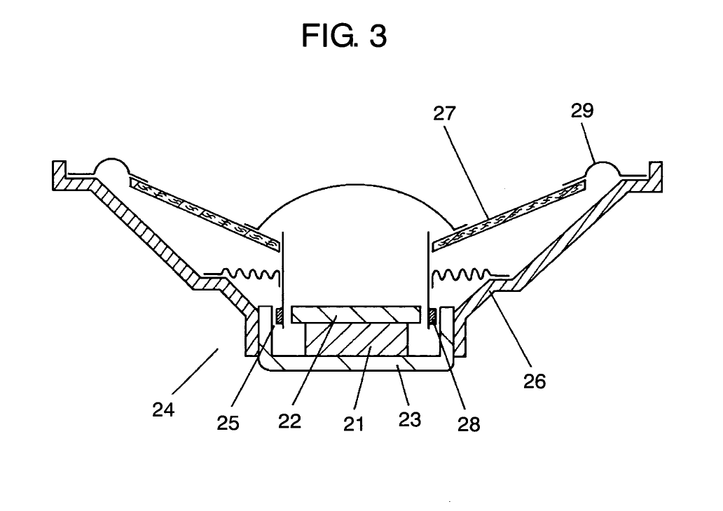

FIG. 3 is a cross sectional view of a speaker of an embodiment of the present invention. As shown in FIG. 3, the speaker has internal magnet-type magnetic circuit 24 in which magnetized magnet 21 is sandwiched between upper plate 22 and yoke 23.

Yoke 23 of magnetic circuit 24 is attached to frame 26. Frame 26 is combined with diaphragm 27 of the first embodiment by bonding its periphery to the circumference of diaphragm 27 via edge 29. Furthermore, voice coil 28 is connected with the center of diaphragm 27 at one end thereof and is fit into magnetic gap 25 at the other end thereof.

Although the speaker of the second embodiment has internal magnet-type magnetic circuit 24, the present invention is not limited to this type and can be applied to speakers having an external magnet-type magnetic circuit. The present invention can further be applied to mini speakers used in mobile phones and the like in which diaphragm 27 and edge 29 are integrated.

Using the diaphragm of the first embodiment in this manner can achieve a speaker which has performance and audio quality adjusted in a wide range, and is excellent in moisture resistance reliability, strength, external appearance and productivity.

A speaker manufactured using the diaphragm of the present invention can create performance and sound with high precision by making use of the physical properties of both a paper diaphragm and a resin diaphragm, which have not been achieved by conventional diaphragms. Furthermore, different color combinations of the diaphragm can allow the speaker to be designed diversely.

In addition, diaphragm 27 can be manufactured in infinite color combinations so as to make the speaker meet the demand for design in addition to the demands for the creation of performance and sound.

### Third Exemplary Embodiment

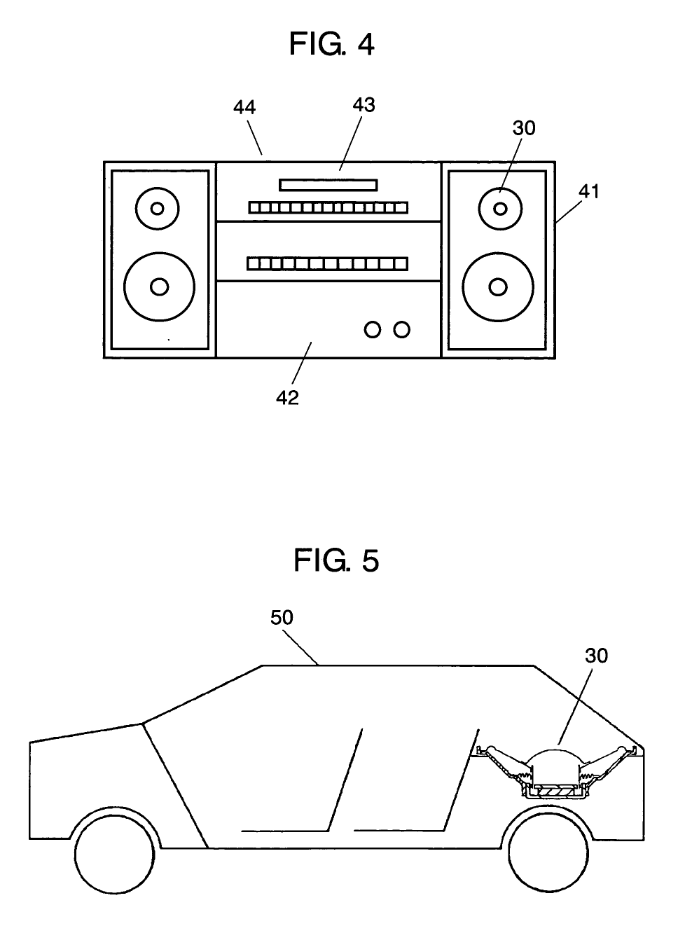

FIG. 4 is an external view of an audio mini component system which is electronic equipment of an embodiment of the present invention. As shown in FIG. 4, speaker 30 of the second embodiment of the present invention is integrated into enclosure 41 to form a speaker system. Audio mini component system 44 as electronic equipment includes amplifier 42 for amplifying electric signals to be inputted to speaker 30, and player 43 for outputting a source to be inputted to amplifier 42.

Using the diaphragm of the present invention can achieve a speaker system, as the electronic equipment, capable of producing performance, sound and design with high precision by using the advantages of both a paper diaphragm and a resin diaphragm, which have not been achieved by conventional diaphragms.

### Fourth Exemplary Embodiment

FIG. 5 is a cross sectional view of car 50, which is a device of an embodiment of the present invention. As shown in FIG. 5, car 50 includes speaker 30 using the diaphragm of the present invention. Speaker 30,is installed in the rear tray or the front panel as a part of a car navigation system or a car audio system.

Speaker 30 can have performance, sound and design created with high precision by using the advantages of both a paper diaphragm and a resin diaphragm. In this manner, cars and other similar devices that are required to have high moisture resistance reliability and strength can have more flexible acoustic designs.

A method and facility of the present invention for manufacturing a speaker diaphragm will be described as follows with reference to drawings.

### Fifth Exemplary Embodiment

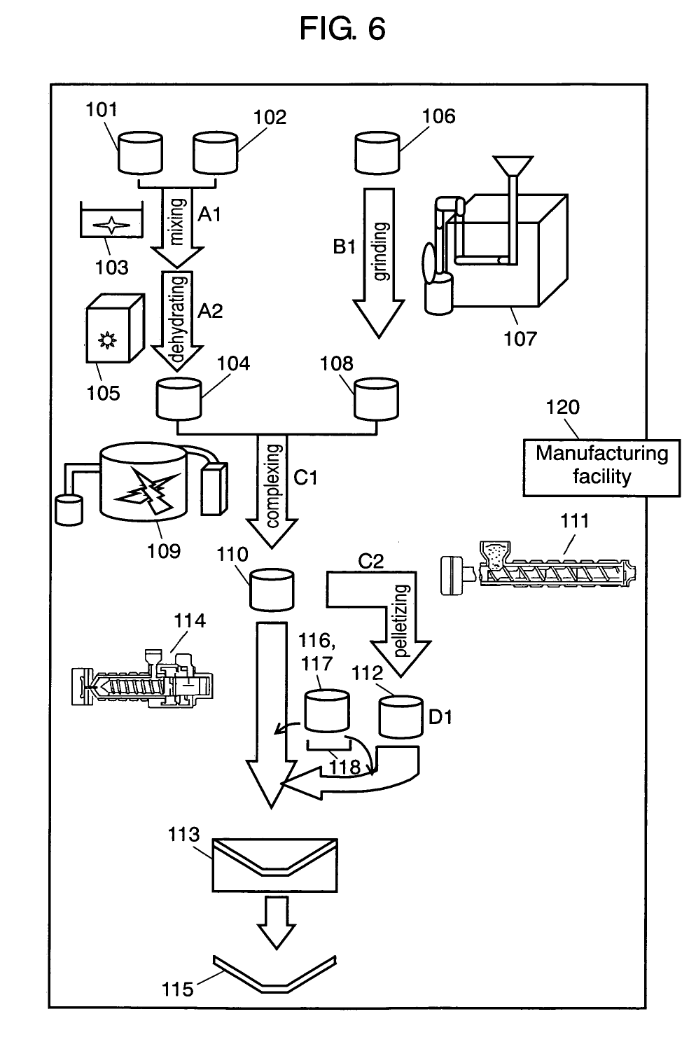

FIG. 6 is a process chart showing a method of an embodiment of the present invention for manufacturing a speaker diaphragm.

At process A1, fibrous PP 101 and pulp 102 as filler are stirred together with a lot of water so as to be fully mixed. At process A2, the resultant mixture is put in dehydrator 105 and dehydrated while maintaining appropriate moisture content, thereby forming primary composite material 104. Pulp 2 as the filler is made of craft pulp (NUKP).

At process B1, PP pellets 106, which is a resin material are ground in grinder 107 to obtain granular PP 108.

At process C1, primary composite material 104 obtained through processes A1 and A2 are complexed again in mixer 109 with granular PP 108 obtained by process B1. This complexing process is performed by substituting fibrous PP 101 and/or granular PP 108 for the moisture contained in primary composite material 104 which has been obtained by wet mixing, thereby improving the dispersibility of pulp 102 and fibrous PP 101 and/or granular PP 108.

A desirable method for the substitution is to dry with heat. More specifically, primary composite material 104 and granular PP 108 are put in mixer 109 and dried with heat so as to evaporate the remaining moisture. At the same time as the evaporation, the fibrous PP and granular PP 108 are melted to substitute the PP for the moisture. The substitution process allows the PP and the pulp to be well blended and efficiently complexed with each other. As a result of this process, secondary composite material 110 is obtained in which the PP and the pulp are better dispersed.

Using injection molder 114, secondary composite material 110 is injected under heat into mold 113 to form diaphragm 115. Finally, diaphragm 115 is taken out of mold 113 after it is cooled and hardened.

The aforementioned processes provide diaphragm 115 in which the pulp is dispersed evenly in the PP.

It is alternatively possible to provide another process C2 at which secondary composite material 110 is pelletized again in pelleting machine 111 before the injection molding. At process C2, injection molder 114 is used to mold injection molding pellets 112 into diaphragm 115 in which the PP and the pulp are well dispersed.

It is alternatively possible to perform process D1 for adding reinforcement 116 such as mica or diluent resin 117 either at the same time as the second complexion at process C1 or after process C1 or C2. Process D1 can adjust the physical properties of the diaphragm more precisely. More specifically, adding reinforcement 116 such as mica can improve the stiffness of the diaphragm. As a result, the speaker has performance and audio quality corresponding to the improved stiffness of the diaphragm. Adding diluent resin 117, on the other hand, can make the diaphragm largely reflect the nature of resin. As a result, the speaker has performance and audio quality corresponding to the nature of resin reflected in the diaphragm.

Using pulp as the filler enables a resin diaphragm to have a nature similar to that of a paper diaphragm. Using PP as the resin can achieve cost reduction and productivity improvement of the diaphragm.

Adopting the diaphragm manufacturing method of the fifth embodiment can make the resin and the filler well blended, thereby drawing out the advantages of both of them. As a result, the speaker with this diaphragm has performance and audio quality adjusted in a wide range and is excellent in moisture and water resistance reliability, strength and external appearance.

Adopting the diaphragm manufacturing method of the fifth embodiment can also achieve the performance value of a paper diaphragm with high productivity and stability, which used to be obtained through a long paper-making process.

### Sixth Exemplary Embodiment

A sixth embodiment will describe a facility of the present invention for manufacturing a speaker diaphragm with reference to FIG. 6.

Manufacturing facility 120 of the present invention includes wet mixer 103 for mixing at least a resin and a filler; dehydrator 105 for dehydrating the mixture; grinder 107 for grinding resin; mixer 109 for complexing materials; injection mold 113; and injection molder 114.

The manufacturing facility can perform kneading fibrous resin and filler by wet mixing; complexing of the resin and the filler; grinding resin into granular form; and complexing through the substitution of the resin for moisture. As a result, the manufacturing facility enables the resin and the filler to be well blended to obtain uniform dispersibility, thereby drawing out the advantages of both the resin and the filler.

The manufacturing facility of the present invention may further include mixing machine 118. Mixing machine 118 mixes the resin and either a resin material containing reinforcement 116 or diluent resin 117. The use of mixing machine 118 allows more precise adjustment of the physical properties of the diaphragm. More specifically, the addition of a resin material containing reinforcement can improve the stiffness of the diaphragm. The addition of a diluent resin, on the other hand, can adjust the physical properties of the diaphragm so as to further improve the resin physical properties of the diaphragm. As a result, the manufacturing facility can improve the dispersibility of the resin and the filler so as to draw out the advantages of both of them, and can precisely adjust the physical properties of the diaphragm.

The fifth and sixth embodiments have thus described the manufacture of a speaker diaphragm. It goes without saying that the manufacturing method and facility of the fifth and sixth embodiments can be applied to the manufacture of a dust cap of the present invention.

### Seventh Exemplary Embodiment

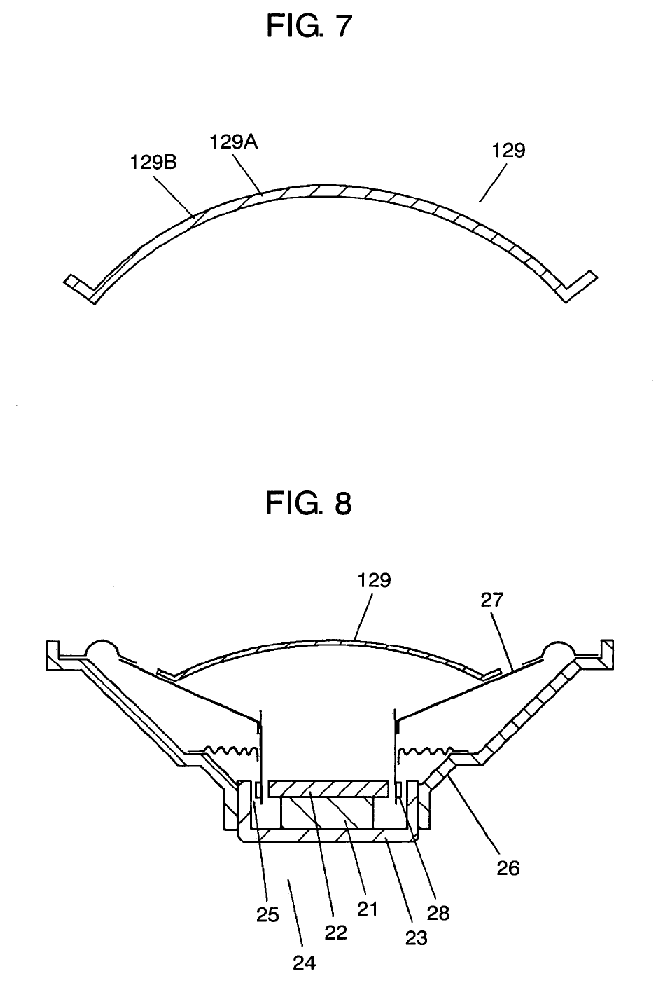

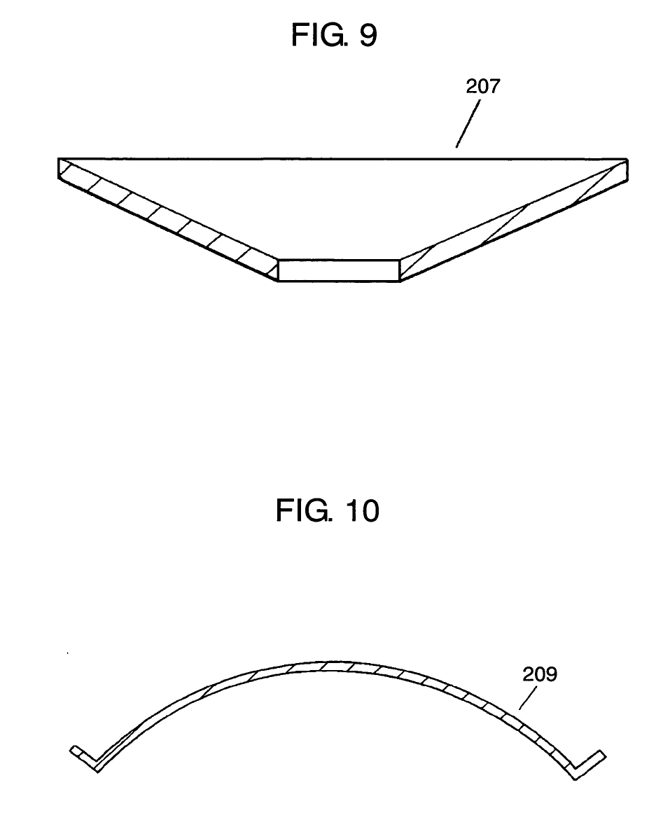

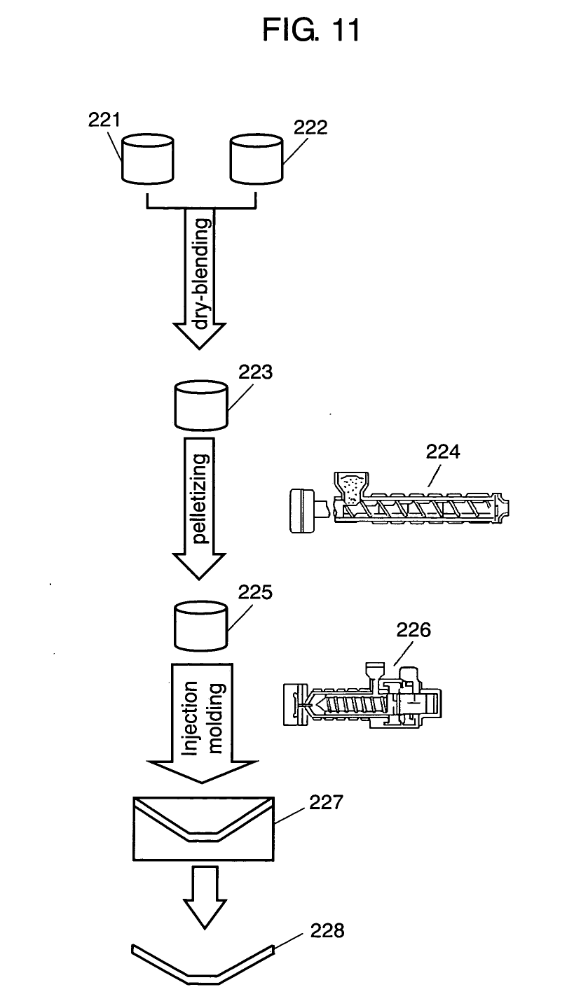

FIG. 7 is a cross sectional view of a dust cap of an embodiment of the present invention.

As shown in FIG. 7, dust cap 129 is formed by injection molding a material containing resin material 129A and fiber material 129B. As resin material 129A of dust cap 129, a crystalline or amorphous olefin resin is used.

As fiber material 129B, it is preferable to use leaf fiber, bast fiber, seed fiber, fruit fiber, and stem fiber either on their own or in combination. Fiber material 129B can further be added with animal fiber. Adding such a material can further approach the desired performance and audio quality of the speaker and can also arbitrarily adjust the performance of the speaker.

In order to achieve the audio quality of the speaker that cannot be obtained by using the aforementioned vegetable fiber, animal fiber such as silk or wool can be added so as to precisely adjust the strength and internal loss of the dust cap.

The diaphragm can be molded using materials added with the following reinforcements: metal fiber such as aluminum; carbon fiber such as carbon, ceramic fiber such as glass or boron; organic high modulus fiber such as aramid; mica; or graphite. Adding such reinforcement can strengthen dust cap 129 or adjust the audio quality of the speaker by producing accented sound or by providing sound pressure frequency characteristics with peaks.

The dust cap material can be also added with zinc oxide whisker or the like so as to achieve the audio quality with internal loss that cannot be satisfied by using the aforementioned materials only.

The afore-described materials can be used either on their own or in combination to adjust the physical properties of dust cap 29 both in a wider range and with high precision, thereby achieving the desired performance and audio quality of the speaker.

Dust cap 129 thus obtained is measured and evaluated for its physical properties and the like. A speaker is prototyped with dust cap 129 so as to measure the characteristics and sound of the speaker, and also to listen through the speaker as the final evaluation.

When the evaluation indicates that the speaker does not achieve the desired performance and audio quality, the prototyping process of the dust cap is repeated over and over again. During the process, the selection and ratio of materials are considered so as to gradually approach the target performance and audio quality of the speaker.

Repeating these processes can achieve the desired or similar performance and audio quality of the speaker.

The fiber material used in the present invention preferably has a fiber length of 0.2 mm to 20 mm. The length of this range can maximize the effectiveness of the fiber material when it is kneaded with a resin material, thereby improving the productivity and quality of the dust cap.

The fiber material of the present invention is added to the resin material preferably at a rate of 5% to 70%. This rate range can maximize the effectiveness of the fiber material when it is kneaded with the resin material, and can also improve the productivity and quality of the dust cap.

As described hereinbefore, the addition of pulp with a large internal loss can reduce the unnecessary peaks and dips caused by a divisional resonance of dust cap 129, which is vibrated with amplitudes received from diaphragm 27 as general effects.

The addition of pulp can also improve the adhesion of a resin with poor adhesion.

As an external design, resin material 129A and fiber material 129B can be in different colors from each other so that the single dust cap 129 can make an appeal that it includes both materials. In this case, it is preferable to choose a transparent or semi-transparent resin.

As described hereinbefore, speaker dust cap 129 of the present invention is formed by injection molding a material containing resin material 129A and fiber material 129B. The unnecessary peaks and dips caused by a divisional resonance can be reduced by the presence of the pulp having a large internal loss.

The present embodiment provides dust cap 129 which combines the advantages of both a paper diaphragm and a resin diaphragm. More specifically, dust cap 129 has a large degree of freedom in setting physical properties as the advantage of a paper diaphragm. Dust cap 129 is also excellent in moisture and water resistance reliability, strength, external appearance, productivity and dimension stability as the advantages of a resin diaphragm.

As a result, dust cap 129 of the present embodiment allows the creation of performance and sound of the speaker by making use of the physical properties of both paper and resin, which have not been achieved conventionally.

Furthermore, the color combination between the fiber material and the resin material can allow the speaker to be designed diversely.

### Eighth Exemplary Embodiment

FIG. 8 is a cross sectional view of a speaker of an embodiment of the present invention. As shown in FIG. 8, the speaker has internal magnet-type magnetic circuit 24 in which magnetized magnet 21 is sandwiched between upper plate 22 and yoke 23.

Yoke 23 of magnetic circuit 24 is attached to frame 26. Frame 26 is combined with diaphragm 27 by bonding its periphery to the circumference of diaphragm 27. Furthermore, voice coil 28 is connected with the center of diaphragm 27 at one end thereof and is fit into magnetic gap 25 at the other end thereof.

Diaphragm 27 has dust cap 129 in its center on the side opposite to voice coil 28.

Although the speaker of the eighth embodiment has internal magnet-type magnetic circuit 24, the present invention is not limited to this type and can be applied to speakers having an external magnet-type magnetic circuit.

The addition of pulp having a large internal loss to the material for dust cap 129 can reduce the unnecessary peaks and dips caused by a divisional resonance.

The addition of such pulp can also allow the speaker to have performance and audio quality adjusted in a wide range.

And a speaker excellent in moisture resistance reliability, strength, external appearance, and productivity is realized.

The use of dust cap 129, which has the physical properties of both paper and resin that have not been achieved conventionally, allows the speaker to have better audio quality and to create the performance and sound with high precision. Furthermore, the color combination between the fiber material and the resin material in dust cap 129 can allow the speaker to be designed diversely.

Dust cap 129 can also be manufactured in various color combinations so as to make the speaker meet the demand for design in addition to the demands for the creation of performance and sound.

As one speaker component, dust cap 129 has more influence to determine the performance and audio quality of the speaker as it grows larger in area, volume and weight.

Since dust cap 129 is located in the front of diaphragm 27, when dust cap 129 has an outside dimension close to that of diaphragm 27, dust cap 129 may have the larger influence to determine the performance and audio quality of the speaker than the diaphragm.

The structure is often used in a super woofer or the like which makes a dust cap physically cut the high-frequency range or the mid- and high-frequency ranges generated from the diaphragm.

The reason for the larger influence may be that although the dust cap generates sound by being vibrated with amplitudes of the diaphragm, more sound directly reaches the human ear from the dust cap than from the diaphragm.

Thus, the performance and audio quality of the speaker are largely affected by the materials and physical properties of the dust cap. As a result, the dust cap may make a higher contribution to the performance and audio quality of the speaker than the other components.

### Ninth Exemplary Embodiment

FIG. 4 is an external view of an audio mini component system which is electronic equipment of an embodiment of the present invention.

Using mini component system 44 shown in FIG. 4, speaker 30 with dust cap 129 of the present invention is integrated into enclosure 41. Mini component system 44 includes speaker 30; amplifier 42 for amplifying electric signals to be inputted to the speaker; and player 43 for outputting a source to be inputted to amplifier 42.

By using dust cap 129 combining the advantages of both paper and resin, speaker 30 of the present invention can form an electric device which has high audio quality and diverse designs, and also creates performance and sound with high precision.

### Tenth Exemplary Embodiment

FIG. 5 is a cross sectional view of car 50, which is a device of an embodiment of the present invention.

As shown in FIG. 5, car 50 includes speaker 30 of the present invention, which is installed in the rear tray or the front panel as a part of a car navigation system or a car audio system.

By using the speaker of the present invention, cars and other similar devices that are required to have high moisture resistance reliability and strength can have more flexible acoustic designs.

In the eighth to tenth embodiments, the concept of the present invention has been applied to dust cap 129. It is possible to combine the dust cap of the present invention with a conventional diaphragm. However, it goes without saying that the dust cap of the present invention can be preferably used together with the diaphragm of the present invention to achieve a speaker or audio/video equipment with higher performance.

### INDUSTRIAL APPLICABILITY

The speaker diaphragm, dust cap, speaker, electronic equipment and device of the present invention can be applied to electronic equipment such as audio/video equipment and information/communication equipment, and also to devices such as cars, all of which are required to create performance and sound with high precision.

The method for manufacturing a speaker diaphragm or a dust cap of the present invention can produce a diaphragm combining the advantages of both a resin material and a fiber material which is used as filler. Therefore, the method can be applied to a method or a device such as a facility for manufacturing a speaker diaphragm or a dust cap used in various kinds of audio equipment which is desired to combine the advantages of both a resin diaphragm and a paper diaphragm.

1. A speaker comprising a diaphragm, wherein
the diaphragm is a injection-molded product made of a mixture containing a resin material and a fiber material.

2. The speaker of claim 1 further comprising a dust cap attached to the diaphragm, wherein
the dust cap is an injection-molded product made of a mixture containing the resin material and the fiber material.

3. The speaker of claim 1, wherein
the resin material is a crystalline olefin resin or an amorphous olefin resin.

4. The speaker of claim 1, wherein
the resin material is one of polypropylene and engineering plastic.

5. The speaker of claim 1, wherein
the fiber material contains at least one of wood fiber, leaf fiber, bast fiber, seed fiber, fruit fiber, stem fiber and animal fiber.

6. The speaker of claim 5, wherein
the wood fiber contains at least one of craft pulp and sulfite pulp.

7. The speaker of claim 1, wherein
the mixture is added with reinforcement.

8. The speaker of claim 1, wherein
the fiber material has a fiber length of 0.2 mm to 20 mm.

9. The speaker of claim 1, wherein
the mixture contains 5% to 70% in weight of the fiber material.

10. The speaker of claim 2, wherein
one of the diaphragm and the dust cap is black or natural color.

11. The speaker of claim 2, wherein
one of the diaphragm and the dust cap includes the resin material and the fiber material, which are different in color from each other.

12. The speaker of claim 11, wherein
one of the diaphragm and the dust cap includes the resin material, which is transparent or semi-transparent.

13. A diaphragm for speakers, the diaphragm being an injection-molded product made of a mixture containing a resin material and a fiber material.

14. The diaphragm of claim 13, wherein
the resin material is a crystalline olefin resin or an amorphous olefin resin.

15. The diaphragm of claim 13, wherein
the fiber material contains at least one of wood fiber, leaf fiber, bast fiber, seed fiber, fruit fiber, stem fiber and animal fiber.

16. The diaphragm of claim 13, wherein
the mixture is added with reinforcement.

17. The diaphragm of claim 13, wherein
the fiber material has a fiber length of 0.2 mm to 20 mm.

18. The diaphragm of claim 13, wherein
the mixture contains 5% to 70% in weight of the fiber material.

19. The diaphragm of claim 13, wherein
the diaphragm is black or natural color.

20. The diaphragm of claim 13, wherein
the diaphragm includes the resin material and the fiber material, which are different in color from each other.

21. The diaphragm of claim 20, wherein
the diaphragm includes the resin material, which is transparent or semi-transparent.

22. A dust cap for speakers, the dust cap being an injection-molded product made of a mixture containing a resin material and a fiber material.

23. The dust cap of claim 22, wherein
the resin material is a crystalline olefin resin or an amorphous olefin resin.

24. The dust cap of claim 22, wherein
the fiber material contains at least one of wood fiber, leaf fiber, bast fiber, seed fiber, fruit fiber, stem fiber and animal fiber.

25. The dust cap of claim 22, wherein
the mixture is added with reinforcement.

26. The dust cap of claim 22, wherein
the fiber material has a fiber length of 0.2 mm to 20 mm.

27. The dust cap of claim 22, wherein
the mixture contains 5% to 70% in weight of the fiber material.

28. The dust cap of claim 22, wherein
the dust cap is black or natural color.

29. The dust cap of claim 22, wherein
the dust cap includes the resin material and the fiber material, which are different in color from each other.

30. The dust cap of claim 29, wherein
the dust cap includes the resin material, which is transparent or semi-transparent.

31. Electronic equipment comprising a speaker, wherein
the speaker including a diaphragm and a dust cap, and
the diaphragm and the dust cap are injection-molded products made of a mixture containing a resin material and a fiber material.

32. The electronic equipment of claim 31 being equipment mounted on a car.

33. A method for manufacturing one of a diaphragm and a dust cap, the method comprising:
wet mixing a fibrous resin and a filler;
forming a primary composite material by dehydrating a mixture of the fibrous resin and the filler;
grinding the resin into a granular form;
forming a secondary composite material by mixing the primary composite material with the resin in the granular form; and
injection molding the secondary composite material.

34. The method of claim 33, wherein
the forming of the secondary composite material includes substituting the resin for moisture.

35. The method of claim 34, wherein
the substituting is granulating a mixture of the primary composite material and the granular resin by drying with heat.

36. The method of claim 33 further comprising:
palletizing the secondary composite material.

37. The method of claim 33 further comprising:
adding reinforcement or a diluent resin, the adding being performed during or after the forming of the secondary composite material.

38. A device for manufacturing one of a diaphragm and a dust cap, the device comprising:
a device for wet mixing a fibrous resin and a filler;
a dehydrator for dehydrating a mixture of the fibrous resin and the filler, thereby forming a primary composite material;
a grinder for grinding resin into a granular form;
a mixer for mixing the primary composite material and the resin in the granular form, thereby forming a secondary composite material; and
an injection molder for molding the secondary composite material.

39. The device of claim 38 further comprising:
a mixer for mixing the secondary composite material and one of a reinforcement-containing resin material and a diluent resin.
